(19) United States
(12) Patent Application Publication
(10) Pub. No.: US 2015/0373423 A1
(43) Pub. Date: Dec. 24, 2015

(54) VIDEO SUPPLY DEVICE, VIDEO ACQUISITION DEVICE, AND PROGRAM

(71) Applicant: SHARP KABUSHIKI KAISHA, Osaka-shi, Osaka (JP)

(72) Inventors: Takuya IWANAMI, Osaka-shi (JP); Shuhichi WATANABE, Osaka-shi (JP); Natarajan SEETHARAMAN, Osaka-shi (JP); Arumugam JAWAHAR, Osaka-shi (JP); Jayanty SUDHAKAR, Osaka-shi (JP)

(73) Assignee: Sharp Kabushiki Kaisha, Osaka-shi, Osaka (JP)

(21) Appl. No.: 14/654,912

(22) PCT Filed: Jan. 8, 2014
(86) PCT No.: PCT/JP2014/050151

§ 371 Date: Jun. 23, 2015

(30) Foreign Application Priority Data
Jan. 15, 2013 (JP) 2013-004895

(51) Int. Cl. H04N 21/658; H04N 21/44; H04N 21/2187; H04N 21/236; H04N 21/858

(52) U.S. Cl. CPC H04N 21/6581; H04N 21/236; H04N 21/8586; H04N 21/2187; H04N 21/44008

(57) ABSTRACT

A server is provided with a video supplier which supplies a captured video of a camera to a client, and the supplier supplies to the client an MPD in which a range of parameter values supported by the camera is indicated.

### TECHNICAL FIELD

The present invention relates to a video supply device and a video supply method which supply a video as well as a video acquisition device and a video acquisition method which acquires a video from the video supply device. Further, the present invention relates to a program which causes a computer to function as such as a video supply device or a video acquisition device and a computer readable recording medium which records such a program therein.

### BACKGROUND ART

MPEG-DASH specifies a standard for streaming media (video, voice and subtitle) with HTTP and is able to be used for streaming of live moving image contents as well as for streaming of recorded moving image contents. In accordance with this standard, a distribution server of moving image contents provides moving image contents with various bit rates, sizes, frame rates and codecs. Further, in the MPEG-DASH, media (voice and subtitle) in which various languages are able to be utilized are able to be designated. A client acquires an appropriate moving image content from the server by using an HTTP protocol based on capability thereof, a bandwidth capable of being utilized in a network, and a setting value designated by a user, and draws the acquired moving image content.

Moreover, in the MPEG-DASH, control metadata of streaming distribution, which is called an MPD, and a media segment which is a transmission unit of HTTP transmission in which a moving image content is time-divided are specified. In the MPD, for each time zone, URLs referred to in order to acquire media segments to be reproduced in the time zone are described.

### SUMMARY OF INVENTION

### Technical Problem

Meanwhile, a distribution server needs to notify parameters (bit rate, size, frame rate, and the like) supported by itself with respect to a client who does not recognize what parameters the distribution server supports.

However, in the MPEG-DASH which has been specified so far, in a case of notifying a client of the parameters supported by itself through the MPD, it is necessary to describe the aforementioned URLs in the MPD as many as the number of combinations of possible values of each parameter for each time zone.

For example, in a case where the distribution server is an IP camera and a moving image content is a video of the IP camera, a pan angle, a tilt angle and a zoom factor are assumed as the parameters. In a case where this IP camera supports the pan angle and the tilt angle from 0° to 180° at intervals of 1° and supports the zoom factor from equal magnification to four times at intervals of 0.1 time, for example, it becomes necessary to describe a vast number of the aforementioned URLs for each time zone in the MPD.

Accordingly, in the MPEG-DASH which has been specified so far, it is impossible for the distribution server to efficiently inform the client of parameters supported by itself through the MPD.

The present invention has been made in view of the above-described problems and a main object thereof is to realize a video supply device capable of efficiently informing a video acquisition device of a range of parameter values supported by itself or external equipment connected to itself. Moreover, the object of the present invention also includes realizing a video acquisition device which acquires, from the video supply device, a video according to a parameter value designated based on information informed from the video supply device.

### Solution to Problem

In order to solve the above-described problems, a video acquisition device according to one aspect of the present invention is provided with a video acquirer which acquires, from a video supply device, a video for which the video supply device or an external device connected to the video supply device serves as a supply source and a metadata acquirer which acquires, from the video supply device, metadata to be referred to for acquiring the video from the video supply device, and is characterized in that the device serving as the supply source of the video is provided with a function of supplying a video according to a parameter value received by the video supply device, the metadata includes a value which explicitly or non-explicitly indicates a range of the parameter value supported by the device serving as the supply source of the video, and the video acquirer acquires the video according to the parameter value within the range by referring to the value.

Moreover, in order to solve the above-described problems, a video supply device according to one aspect of the present invention is provided with a video supplier which supplies, to a video acquisition device, a video for which an own device or an external device connected to the own device serves as a supply source and a metadata supplier which supplies, to the video acquisition device, metadata which the video acquisition device refers to for acquiring the video from the own device, and is characterized in that the device serving as the supply source of the video is provided with a function of supplying a video according to a parameter value received by the own device, and the metadata includes a value which explicitly or non-explicitly indicates a range of the parameter value supported by the device serving as the supply source of the video.

### Advantageous Effects of Invention

The video supply device and a video supply method of the video supply device according to one aspect of the present invention are able to efficiently inform the video acquisition device of the range of parameter values supported by itself or external equipment connected to itself. Moreover, the video acquisition device and a video acquisition method according to one aspect of the present invention are able to acquire, from the video supply device, the video according to the parameter value designated based on the information informed from such a video supply device.

### BRIEF DESCRIPTION OF DRAWINGS

FIG. 1 is a system configuration view showing a configuration of a camera video distribution system according to one embodiment of the present invention;

FIG. 2 is a block diagram showing main configurations of a DASH server and a DASH client which configure the camera video distribution system of FIG. 1;

FIG. 3 is a view showing one example of MPD data that the DASH server of FIG. 2 distributes to the DASH client of FIG. 2;

FIG. 4 is a sequence view showing exchange between the DASH server of FIG. 2 and the DASH client of FIG. 2;

FIG. 5 is a block diagram showing main configurations of a DASH server and a DASH client which configure a camera video distribution system according to another one embodiment of the present invention;

FIG. 6 is a view showing one example of MPD data that the DASH server of FIG. 5 distributes to the DASH client of FIG. 5;

FIG. 7 is a sequence view showing exchange between the DASH server of FIG. 5 and the DASH client of FIG. 5;

FIG. 8 is a block diagram showing main configurations of a DASH server and a DASH client which configure a camera video distribution system according to still another one embodiment of the present invention;

FIG. 9 is a sequence view showing exchange between the DASH server of FIG. 8 and the DASH client of FIG. 8;

FIG. 10 is a view showing definition of a document structure of MPD data that the DASH server of FIG. 8 distributes to the DASH client of FIG. 8;

FIG. 11 is a view showing one example of the MPD data that the DASH server of FIG. 8 distributes to the DASH client of FIG. 8; and

FIG. 12 is a block diagram showing a main configuration of an IP camera which configures a camera video distribution system according to yet another one embodiment of the present invention.

### DESCRIPTION OF EMBODIMENTS

### Embodiment 1

Description will be given for a camera video reproduction system according to one embodiment of the present invention with reference to drawings.

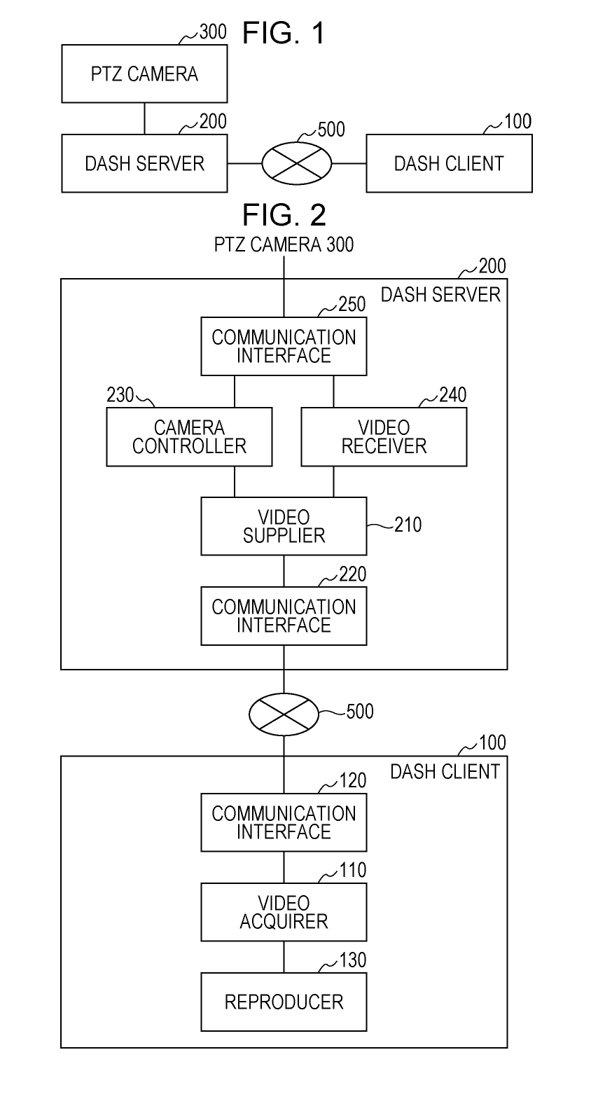

FIG. 1 is a system configuration view showing a configuration of the camera video reproduction system according to the present embodiment.

As shown in FIG. 1, the camera video reproduction system according to the present embodiment includes a DASH client 100, a DASH server 200 and a PTZ (pan-tilt-zoom) camera 300. Moreover, as shown in FIG. 1, the PTZ camera 300 is connected to the DASH server 200, and the DASH client 100 and the DASH server 200 are configured so as to communicate with each other via the Internet 500.

The DASH server 200 is a distribution server which distributes a captured video of the PTZ camera 300 in accordance with regulation of MPEG-DASH and the DASH client 100 is a reproduction device which reproduces a video in accordance with the regulation of the MPEG-DASH.

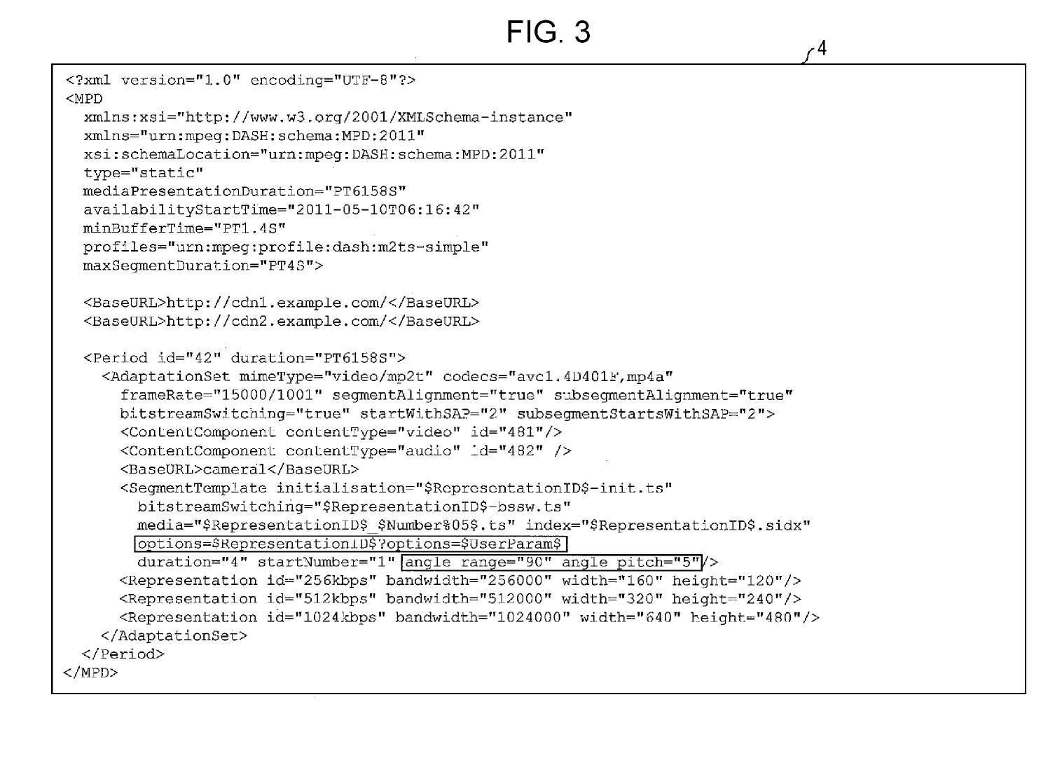

Description will hereinafter be given for main configurations of the DASH client 100 and the DASH server 200 with reference to FIG. 2 and FIG. 3.

FIG. 2 is a block diagram showing the main configurations of the DASH client 100 and the DASH server 200. FIG. 3 is a view in which MPD data is exemplified.

### (DASH Server 200)

As shown in FIG. 2, the DASH server 200 is provided with a video supplier 210, a communication interface 220, a camera controller 230, a video receiver 240 and a communication interface 250.

The video supplier 210 supplies, to the DASH client 100 via the communication interface 220, MPD data which indicates an acquisition destination of each media segment to be acquired in order to reproduce a captured video of the PTZ camera.

Moreover, in response to a request from the DASH client 100, the video supplier 210 controls the PTZ camera 300 as well as supplies the captured video (more specifically, each media segment which configures the captured video) for which the PTZ camera 300 serves as a supply source to the DASH client 100 via the communication interface 220.

The communication interface 220 is an interface which is compatible with TCP/IP communication.

The camera controller 230 controls pan-tilt-zoom operation of the PTZ camera 300 in response to the request from the DASH client 100.

The video receiver 240 receives the captured video from the PTZ camera 300 via the communication interface 250, and supplies the received captured video to the video supplier 210.

The communication interface 250 is an interface which serves as a connection destination of a cable connecting between the DASH server 200 and the PTZ camera 300.

### (DASH Client 100)

As shown in FIG. 2, the DASH client 100 is provided with a video acquirer 110, a communication interface 120 and a reproducer 130.

The video acquirer 110 acquires MPD data from the DASH server 200 via the communication interface 120. The MPD data indicates a range of control parameter values that the PTZ camera 300 supports. For example, in MPD data 4 of FIG. 3, two attribute values of an angle_range attribute and an angle_pitch attribute of a SegmentTemplate element indicate that the PTZ camera 300 supports a pan angle and a tilt angle from 0° to 90° at intervals of 5°. The video acquirer 110 includes a parameter value within the range into a query string by referring to this range, and accesses a URL whose host name is the DASH server 200 to thereby control the PTZ camera 300 indirectly.

Moreover, the video acquirer 110 refers to the MPD data and accesses a URL which indicates an acquisition destination of media segments to thereby acquire each media segment.

The communication interface 120 is an interface which is compatible with TCP/IP communication.

The reproducer 130 reproduces each media segment which is acquired by the video acquirer 110.

### (Operation of Camera Video Reproduction System)

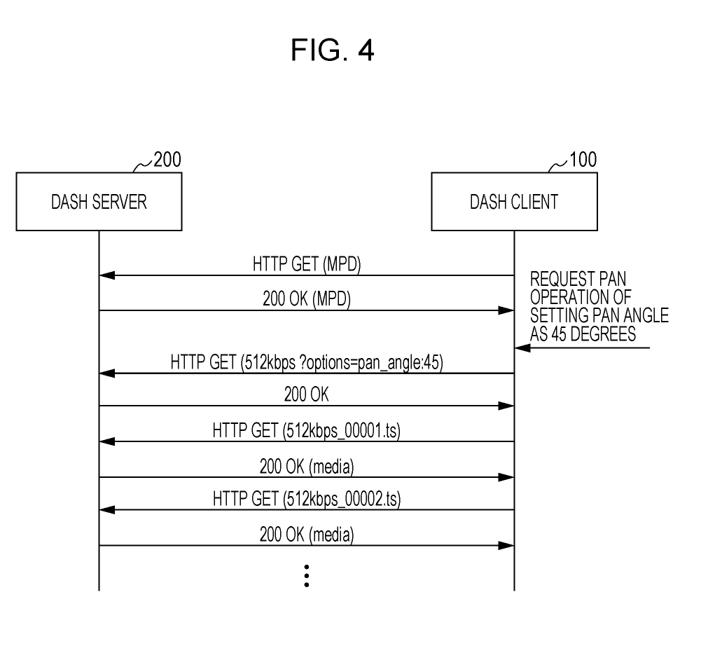

Next, description will be given for operation of the camera video reproduction system according to the present embodiment with reference to FIG. 3 and FIG. 4. FIG. 4 is a sequence view showing the operation of this camera video reproduction system.

As shown in FIG. 4, first, the DASH client 100 acquires MPD data from the DASH server 200. Specifically, the video acquirer 110 transmits a request of the MPD data to the DASH server 200, and receives the MPD data in response thereto.

Next, the video acquirer 110 identifies a range of a control parameter value that the PTZ camera 300 supports by referring to the MPD data, and displays a user interface by which an arbitrary value within the identified range is able to be designated on a displayer (not shown). When the control parameter value is designated by using this user interface by a user, the video acquirer 110 creates a URL which includes the designated control parameter value as a value of a key of options (or a part thereof). For example, when “a pan angle of 45°” and “a bit rate of 512 kbps” are designated by the user, by substituting substitution variables of $UserParam$ and $RepresentaionID$ for “pan_angle:45” and “512 kbps”, respectively, a URL as below which has the value of the key of options as “pan_angle:45” is created from the MPD data 4. http://cdn1.example.com/camera1/512 kbps?options=pan_angle:45 Here, “cdn1.example.com” is a host name of the DASH server 200 and “camera1” is an identification character string specific to the PTZ camera 300, and these character strings are contents of a BaseURL element in the MPD data.

Next, the video acquirer 110 transmits an HTTP GET request including the created URL to the DASH server 200.

When receiving the HTTP GET request via the communication interface 220, the video supplier 210 of the DASH server 200 transmits an HTTP response which indicates success of the request to the DASH client 100. Moreover, the video supplier 210 refers to the URL of the received HTTP GET request to thereby identify the control parameter value designated by the user and notifies the camera controller 230 of the identified control parameter value.

The camera controller 230 controls the PTZ camera 300 via the communication interface 250 based on the identified control parameter value. In the aforementioned example, the camera controller 230 controls the PTZ camera 300 so as to have the pan angle of 45°.

The video acquirer 110 of the DASH client 100 which has received the HTTP response transmits an HTTP GET request for requesting media segments to the DASH server 200. Specifically, the video acquirer 110 substitutes substitution variables of $RepresentationID$ and $Number %05$ constituting a character string which is an attribute value of a media attribute (corresponding to “common character string” in Claims) for the bit rate designated by the user and a five-digit numerical value corresponding to the present time, respectively, to thereby generate a file name of the media segments. Then, the video acquirer 110 generates a URL including this file name and transmits an HTTP GET request including the generated URL to the DASH server 200B. When receiving the HTTP GET request via the communication interface 220, the video supplier 210 codes a captured video supplied from the video receiver 240, creates media segments corresponding to the HTTP GET request, and transmits the created media segments to the DASH client 100. In the aforementioned example, media segments having the bit rate of 512 kbps are supplied to the DASH client 100. Note that, this operation is performed also as to following media segments in the same manner.

Note that, after this, the DASH client 100 requests transmission of subsequent media segments having the same bit rate to the DASH server 200 sequentially, and the DASH server 200 is to transmit the requested media segments to the DASH client 100 sequentially.

### (Advantage of DASH Server 200)

As above, the DASH server 200 is provided with the video supplier 210 which supplies the captured video for which the PTZ camera 300 serves as a supply source to the DASH client 100, and the video supplier 210 supplies the MPD data which the DASH client 100 refers to in order to acquire the captured video from the DASH server 200 to the DASH client 100.

Moreover, the PTZ camera 300 is provided with a function of supplying the captured video according to the parameter value received by the DASH server 200 (for example, a value of the pan angle), and the MPD data includes the attribute value which indicates the range of the parameter value that the PTZ camera 300 supports.

With the configuration described above, an effect is exerted that the DASH server 200 is able to efficiently inform the DASH client 100 of the range of the parameter value that the PTZ camera 300 connected to itself supports by the above-described attribute value.

### (Advantage of DASH Client 100)

As above, the DASH client 100 is provided with the video acquirer 110 which acquires the captured video for which the PTZ camera 300 serves as the supply source from the DASH server 200, and the video acquirer 110 is to acquire, from the DASH server 200, the MPD data referred to in order to acquire the captured video from the DASH server 200.

Moreover, the PTZ camera 300 is provided with the function of supplying the captured video according to the parameter value received by the DASH server 200 (for example, a value of the pan angle), and the MPD data includes the attribute value which indicates the range of the parameter value that the PTZ camera 300 supports.

Then, the video acquirer 110 is to acquire the captured video according to the parameter value within the above-described range from the DASH server 200 by referring to the above-described attribute value indicated in the MPD data.

With the configuration described above, an effect is exerted that the DASH client 100 is able to acquire, from the DASH server 200, the captured video of the PTZ camera 300 according to the parameter value designated based on information informed from the DASH server 200.

### (Additional Matter 1 of Embodiment 1)

Note that, in the MPD data, the range of the above-described parameter value may be indicated non-explicitly as in the example of the aforementioned two attribute values of the angle_range attribute and the angle_pitch attribute, or the parameter values in the above-described range may be indicated explicitly one by one.

Further, the above-described range of the parameter value may be indicated with a maximum value and a minimum value within the range, or the above-described range of the parameter value may be indicated by using an increment value in addition to the maximum value and the minimum value.

### (Additional Matter 2 of Embodiment 1)

The above-described parameter value is not limited to a value indicating a pan angle or a tilt angle. The above-described parameter value may be a value indicating an image size, or may be a value indicating a type of a codec. Moreover, the above-described parameter value may be a value indicating whether to cause the PTZ camera 300 to perform color image capturing or perform monochromatic image capturing, or may be a value indicating whether to turn a night mode of the PTZ camera 300 on or off.

### (Additional Matter 3 of Embodiment 1)

In the above-described embodiment 1, it is set that the DASH client 100 includes the parameter value (pan angle) designated by the user into a query string to transmit to the DASH server 200. The present invention is not limited to such a configuration. That is, instead of the HTTP GET request including the URL of “http://cdn1.example.com/camera1/512 kbps?options=pan_angle:45”, an HTTP GET request including a URL of “http://cdn1.example.com/camera1/512 kbps” and a custom header such that a header value thereof is “pan_angle=45” may be transmitted.

In this case, the DASH server 200 is to control the PTZ camera 300 based on the header value of the custom header in the HTTP GET request.

When receiving the above-described HTTP GET request, for example, the DASH server 200 controls the PTZ camera 300 so that the pan angle of the PTZ camera 300 becomes 45° based on the custom header such that the header value thereof is “pan_angle=45”.

Moreover, for example, when receiving an HTTP GET request including a custom header such that a header value thereof is “tile_angle=30;zoom_factor=2.0”, the DASH server 200 controls the PTZ camera 300 so that the tilt angle of the PTZ camera 300 becomes 30° and a zoom factor becomes twice of one at the time of image capturing at a wide angle end. Citing still another example, when receiving an HTTP GET request including a custom header such that a header value thereof is “night_vision=true”, the DASH server 200 enables the night mode of the PTZ camera 300.

### (Additional Matter 4 of Embodiment 1)

When the DASH client 100 receives a request of the MPD data, the DASH server 200 may transmit different MPD data according to a situation at that time (for example, a load situation of the DASH server 200 or a load situation of a network to which the DASH server 200 belongs).

For example, in a case where the load of the DASH server 200 or the above-described network when receiving the request is higher than a predetermined criterion, the DASH server 200 may transmit MPD data different from the MPD data 4 of FIG. 3 to the DASH client 100. That is, MPD data in which two Representation elements which have attribute values of an id attribute as “256 kbps” and “512 kbps” are described and a Representation element which has an attribute value of the id attribute as “1024 kbps” is not described may be transmitted.

Thereby, with respect to the DASH client 100 which has requested the MPD data when the load of the DASH server 200 or the network is high, the DASH server 200 becomes unable to transmit media segments whose bit rate is 1024 kbps. Accordingly, it can be said that the DASH server 200 which is configured in such a manner has an advantage of being able to distribute a captured video of the PTZ camera 300 appropriately according to the situation.

### Embodiment 2

Description for a camera video reproduction system according to another one embodiment of the present invention with reference to drawings will be as follows. Note that, for convenience of the description, as to members which have the same functions as those of members described in the aforementioned embodiment, the same reference signs are assigned, and description thereof will be omitted.

The camera video reproduction system according to the present embodiment includes a DASH client 100A, a DASH server 200A and the PTZ (pan-tilt-zoom) camera 300.

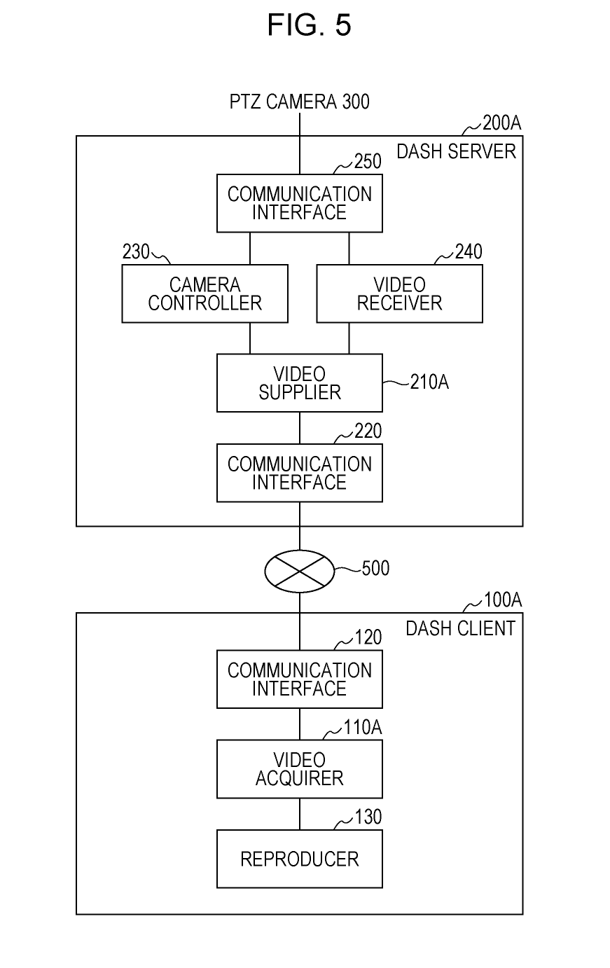

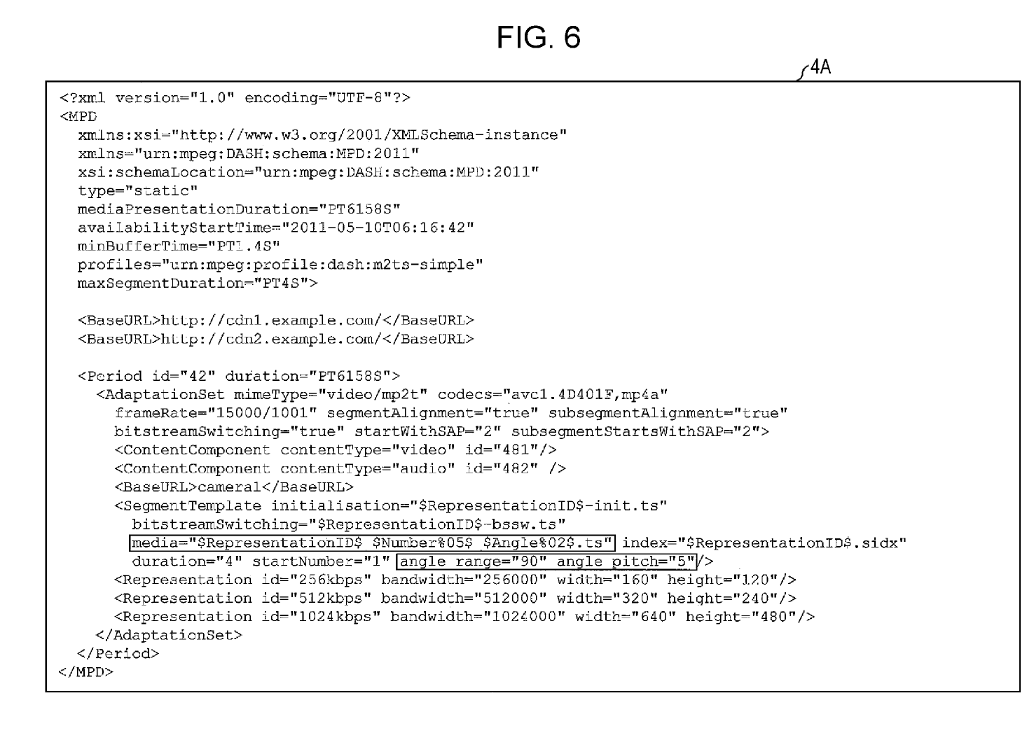

Description will hereinafter be given for main configurations of the DASH client 100A and the DASH server 200A with reference to FIG. 5 and FIG. 6.

FIG. 5 is a block diagram showing the main configurations of the DASH client 100A and the DASH server 200A. FIG. 6 is a view in which MPD data is exemplified.

### (DASH Client 100A)

As shown in FIG. 5, the DASH client 100A is provided with a video acquirer 110A, the communication interface 120 and the reproducer 130.

The video acquirer 110A acquires MPD data from the DASH server 200A via the communication interface 120. The MPD data indicates a range of a control parameter value that the PTZ camera 300 supports (that is, which is effective for the PTZ camera 300) (in the example of MPD data 4A in FIG. 6, a range of a pan angle). The video acquirer 110A sequentially requests media segments showing a captured video at a desired pan angle within the above-described range by referring to this range, which are media segments having a desired bit rate, and sequentially receives the requested media segments.

### (DASH Server 200A)

As shown in FIG. 5, the DASH server 200A is provided with a video supplier 210A, the communication interface 220, the camera controller 230, the video receiver 240 and the communication interface 250.

The video supplier 210A supplies the MPD data to the DASH client 100A via the communication interface 220.

Moreover, when receiving the aforementioned request from the DASH client 100A, the video supplier 210A notifies the camera controller 230 of the pan angle designated by the DASH client 100A. Then, the video supplier 210A supplies the media segments showing the captured video at the designated pan_angle, which are the media segments having a bit rate designated by the DASH client 100A, to the DASH client 100A.

### (Operation of Camera Video Reproduction System)

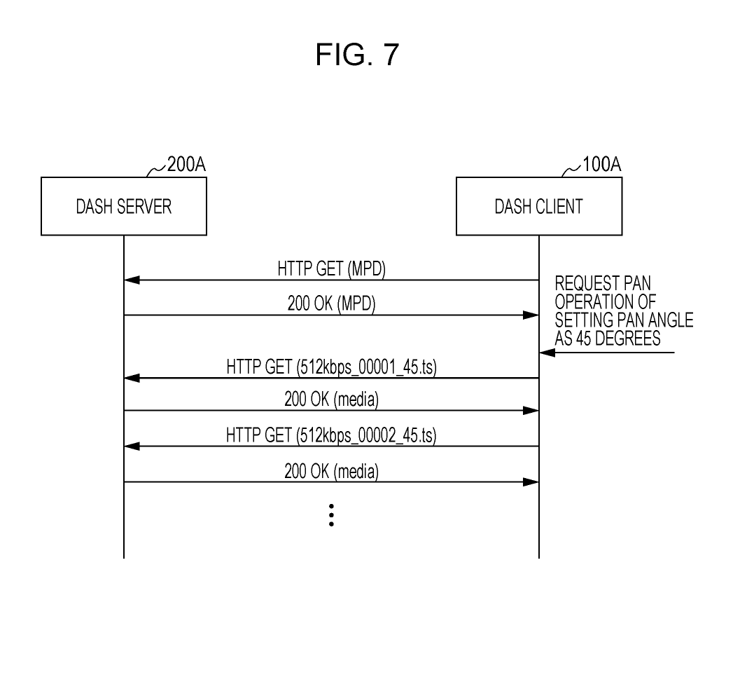

Next, description will be given for operation of the camera video reproduction system of the present embodiment with reference to FIG. 6 and FIG. 7. FIG. 7 is a sequence view showing the operation of this camera video reproduction system.

As shown in FIG. 7, first, the DASH client 100A acquires MPD data from the DASH server 200A. Specifically, the video acquirer 110A transmits a request of the MPD data to the DASH server 200A, and receives the MPD data in response thereto.

Next, the video acquirer 110A identifies a range of a control parameter value that the PTZ camera 300 supports by referring to the MPD data, and displays a user interface by which an arbitrary value within the identified range is able to be designated on a displayer (not shown). When the control parameter value is designated by using this user interface by a user, the video acquirer 110 creates a URL which includes the designated control parameter value as a part of a file name of media segments. For example, when “a pan angle of 45°” and “a bit rate of 512 kbps” are designated by the user, by substituting substitution variables of $RepresentaionID$, $Number %05$ and $UserParam$ for “512 kbps”, “00001” and “45”, respectively, a URL as below is created from the metadata 4A. http://cdn1.example.com/camera1/512 kbps_{—}00001_{—}45.ts” Here, “cdn1.example.com” is a host name of the DASH server 200A, “camera1” is an identification character string specific to the PTZ camera 300, and “512 kbps_{—}00001_{—}45.ts” is the file name of the media segments.

Next, the video acquirer 110A transmits an HTTP GET request including the created URL to the DASH server 200A.

When receiving the HTTP GET request via the communication interface 220, the video supplier 210A of the DASH server 200A refers to the URL (specifically, a name of a is file in a URL character string) of the received HTTP GET request to thereby identify the control parameter value designated by the user and notifies the camera controller 230 of the identified control parameter value.

The camera controller 230 controls the PTZ camera 300 via the communication interface 250 based on the identified control parameter value. In the aforementioned example, the camera controller 230 controls the PTZ camera 300 so as to have the pan angle of 45°.

The video supplier 210A thereafter codes a captured video supplied from the video receiver 240, creates media segments corresponding to the HTTP GET request, and transmits the created media segments to the DASH client 100A. In the aforementioned example, the media segments showing the captured video having the bit rate of 512 kbps and the pan angle of 45° are transmitted to the DASH client 100A.

Note that, after this, the DASH client 100A requests transmission of subsequent media segments showing the captured video at the same pan angle, which are media segments having the same bit rate, to the DASH server 200A sequentially, and the DASH server 200A is to transmit the requested media segments to the DASH client 100A sequentially.

### (Advantages of DASH Client 100A and DASH Server 200A)

From the description above, it should be easily understood that the DASH server 100A and the DASH server 200A exert working effects same as those of the DASH server 100 and the DASH server 200 of the embodiment 1, respectively.

Moreover, the video acquirer 110A of the DASH client 100A creates the URL transmitted to the DASH server 200A in order to acquire the media segments, and a character string of “$RepresentationID$_$Number %05$_$Angle %02$.ts” to be referred to in order to create this URL is included in the MPD data as an attribute value of a media attribute of a SegmentTemplate element. Furthermore, in this character string, a substitution variable of “$Angle %02$” which is substituted for the parameter value (pan angle) designated by the user within the range that the PTZ camera 300 supports is included.

Then, the DASH server 200A controls the PTZ camera 300 so that the pan angle of the PTZ camera 300 becomes the pan angle designated by the user based on the name of the is file in the URL received from the DASH client 100A. The DASH server 200A then transmits the media segments having the bit rate designated by the user, which show the captured video at the pan angle designated by the user, to the DASH client 100A.

With the configuration described above, the DASH client 100A does not need to perform operation for controlling the PTZ camera 300 before performing operation for acquiring the media segments. In other words, the DASH client 100A exerts an effect that both of control of the PTZ camera 300 and acquisition of the media segments are able to be realized only by performing operation for acquiring the media segments, which is superior to that of the DASH client 100.

Note that, in the present embodiment, the range of the pan angle is shown as the range of the control parameter, but, without limitation to panning, a range of a tilt angle or a zoom factor may be shown as the range of the parameter associated with tilting or zooming. In addition, a classification of the control parameter (for example, a character string of “pan”) and the range of the control parameter value (for example, a character string indicating the range of the “pan angle”) may be written together to be shown. Furthermore, for example, as to a plurality of control parameters such as panning and tilting, types of the control parameters and the control parameter values may be written together to be shown.

### Embodiment 3

Description will be given for a camera video reproduction system according to another one embodiment of the present invention with reference to drawings. Note that, for convenience of the description, as to members which have the same functions as those of members described in the aforementioned embodiments, the same reference signs are assigned, and description thereof will be omitted.

Currently, MPEG-DASH supports media representation according to a codec, a bit rate, an image size, a necessary bandwidth, a frame rate, a language and the like, but does not support device specific media representation. For example, the current MPEG-DASH does not support media representation for using functions including panning, tilting, zooming and night vision, which is supported by an IP camera. Moreover, for example, the current MPEG-DASH does not support media representation for using functions including mirroring and rotation, which is supported by a media processing system.

The camera video reproduction system according to the present embodiment supports such device specific media representation, and description of the present embodiment includes description regarding contents below.

How a DASH server describes device specific media representation in an MPD.

What a DASH client does when receiving the MPD including the device specific representation.

As to a message exchanged between the DASH client and the DASH server in a case where the camera video reproduction system performs processing based on the device specific media representation according to operation by a user.

The camera video reproduction system according to the present embodiment includes a DASH client 100B, a DASH server 200B and the PTZ (pan-tilt-zoom) camera 300.

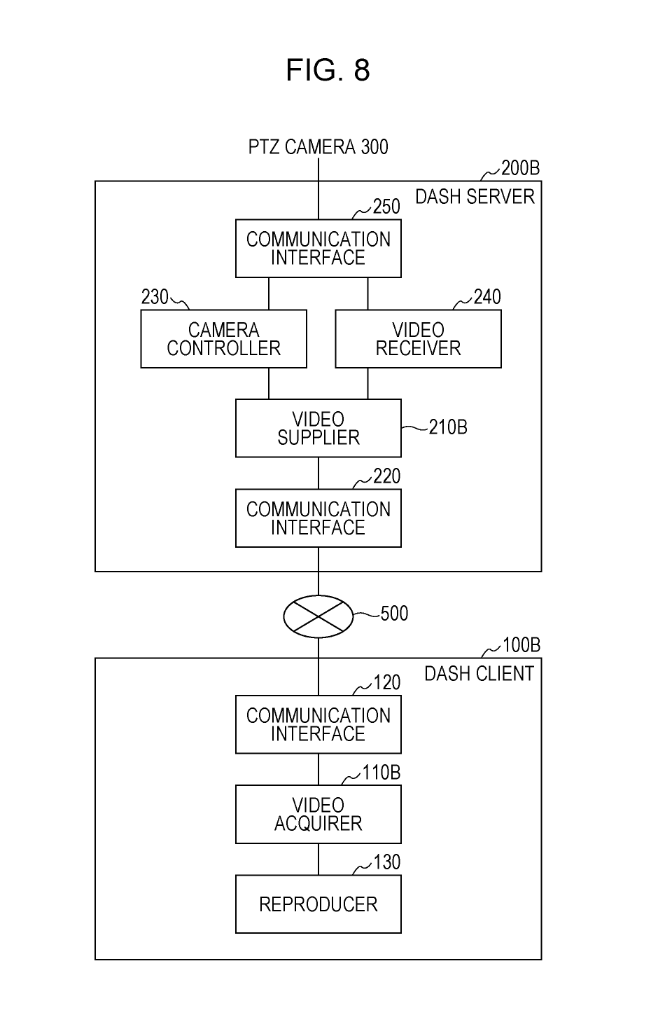

Description will hereinafter be given for main configurations of the DASH client 100B and the DASH server 200B with reference to FIG. 8 and FIG. 11.

FIG. 8 is a block diagram showing the main configurations of the DASH client 100B and the DASH server 200B. FIG. 11 is a view in which MPD data is exemplified.

### (DASH Client 100B)

As shown in FIG. 8, the DASH client 100B is provided with a video acquirer 110B, the communication interface 120 and the reproducer 130.

The video acquirer 110B acquires MPD data from the DASH server 200B via the communication interface 120. The MPD data indicates a range of a control parameter value that the PTZ camera 300 supports (in the example of MPD data 4B in FIG. 11, ranges of a pan angle, a tilt angle and a zoom factor). With respect to the DASH server 200B, the video acquirer 110B notifies the control parameter value within this range determined based on the operation of the user. Thereby, the PTZ camera 300 is controlled in accordance with the control parameter value, and the video acquirer 110B sequentially requests media segments having a desired bit rate, which show a captured video of the controlled PTZ camera 300, and sequentially receives the requested media segments.

### (DASH Server 200B)

As shown in FIG. 8, the DASH server 200B is provided with a video supplier 210B, the communication interface 220, the camera controller 230, the video receiver 240 and the communication interface 250.

The video supplier 210B supplies the MPD data to the DASH client 100B via the communication interface 220.

Moreover, the video supplier 210B controls a pan-tilt-zoom mechanism of the PTZ camera 300 based on the control parameter value notified from the DASH client 100B. Furthermore, the video supplier 210B supplies the captured video (more specifically, each media segment constituting the captured video) of the controlled PTZ camera 300 to the DASH client 100B in accordance with a request from the DASH client 100B.

### (As to Document Structure of MPD Data)

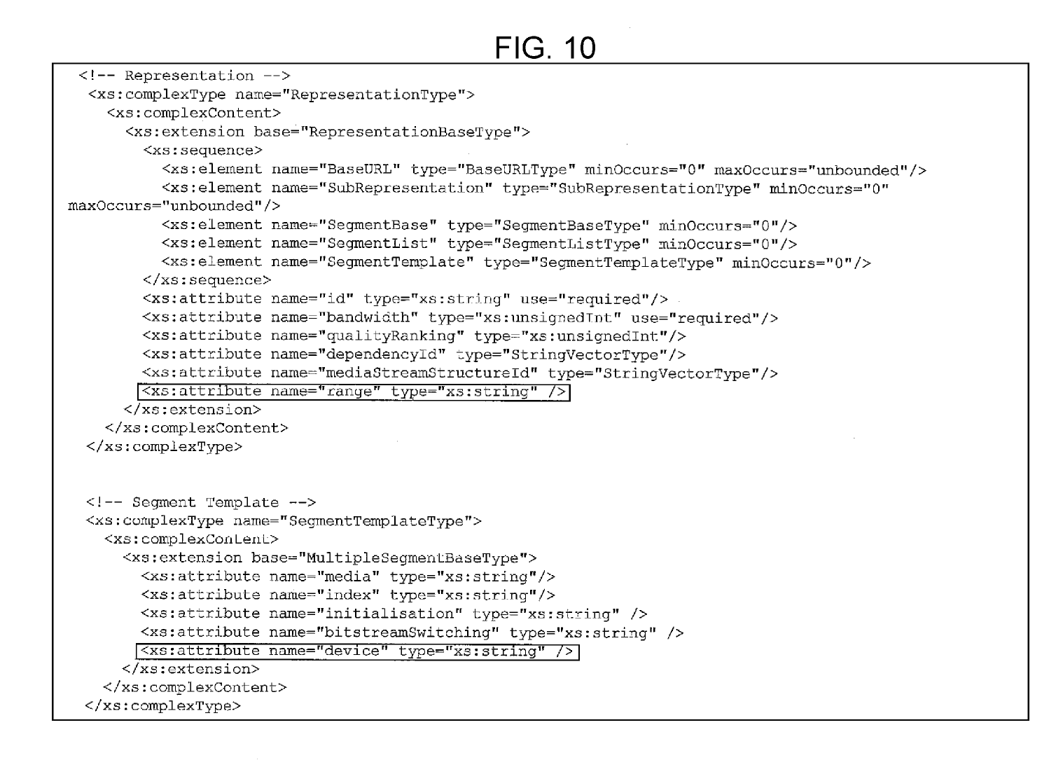

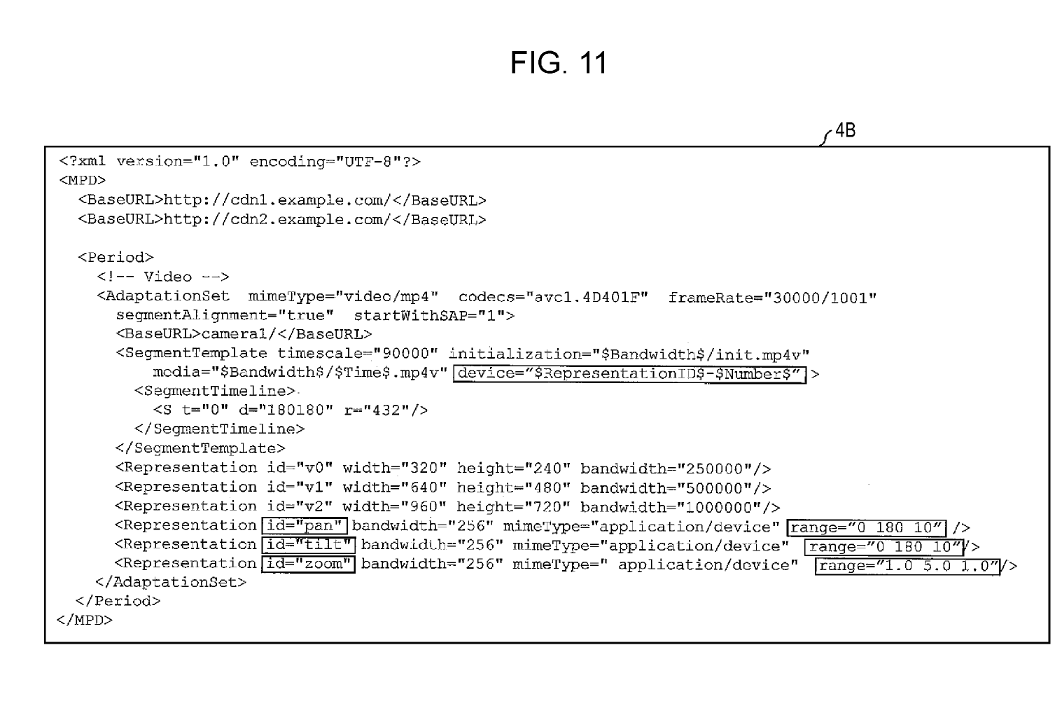

Definition of a document structure of the MPD data is shown in FIG. 10. FIG. 10 is a view showing the definition of the document structure of the MPD data distributed from the DASH server 200B to the DASH client 100B.

A range attribute and a device attribute which are shown by being surrounded with a frame in FIG. 10 are attributes newly added in the present invention. In the present embodiment, the range attribute which is new is to be an attribute value of a Representation element. Moreover, the “device” attribute which is new is to be an attribute value of a SegmentTemplate element.

In the present embodiment, the attribute value of the range attribute is a character string composed of three numerical values separated by a space, and a head and a middle of the numerical values indicate a minimum value and a maximum value of the control parameter value that the PTZ camera 300 supports, respectively. Moreover, a final of the numerical value indicates an increment value. Further, the attribute value of the device attribute is a character string including two substitution variables (substitution parameters) of $RepresentationID$ and $Number$. The substitution variable of $RepresentationID$ is substituted for a value indicating a classification of control instructed by the user and the substitution variable of $Number$ is substituted for the control parameter value.

Note that, in order to create the MPD data, the DASH server 200B needs to identify the maximum value, the minimum value and the increment value of the control parameter value that the PTZ camera 300 supports as to each of pan-tilt-zoom control. Thus, for example, the DASH server 200B may be configured so as to be able to acquire, when the PTZ camera 300 is connected, performance information thereof (performance information including the maximum value, the minimum value and the increment value which are described above) from the PTZ camera 300.

### (Operation of Camera Video Reproduction System)

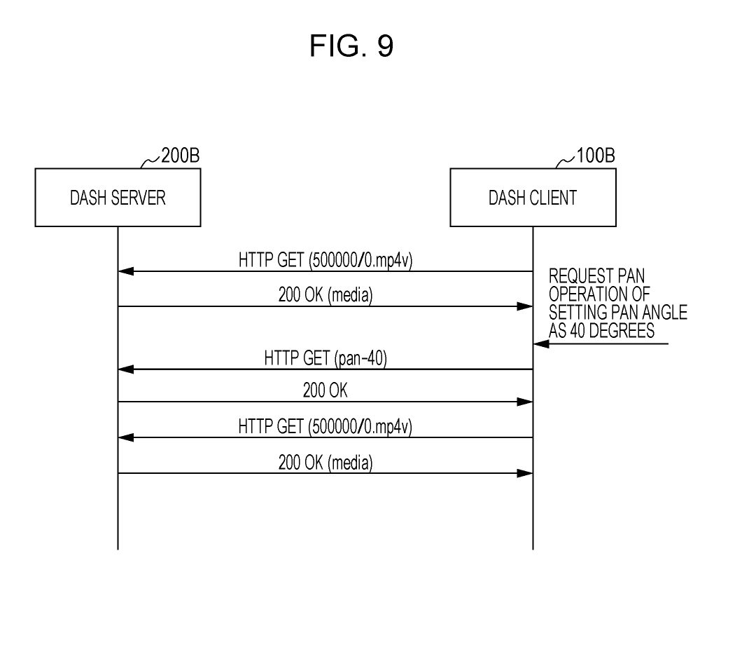

Next, description will be given for operation of the camera video reproduction system according to the present embodiment with reference to FIG. 9 and FIG. 11. FIG. 9 is a sequence view showing the operation of this camera video reproduction system. FIG. 11 is the view showing one example of the MPD data that has been distributed from the DASH server 200B to the DASH client 100B. In FIG. 11, a Representation element having an attribute value of a mimeType attribute as “application/device” is an element (device specific media representation) to be referred to in order to control the PTZ camera 300, and a Representation element whose attribute value of the mimeType attribute is not designated is an element to be referred to in order to acquire media segments.

First, the video acquirer 110B of the DASH client 100B creates a URL for acquiring media segments corresponding to a captured video of the present time, which has a desired bit rate, based on a bandwidth attribute of the Representation element and a media attribute of the SegmentTemplate element in the MPD data, and transmits an HTTP GET request including this URL to the DASH server 200B as shown in FIG. 9. Citing the example of FIG. 11, in a case where the user performs operation for reproducing a captured video of 500 kbps, substitution variables of $Bandwidth$ and $Time$ which constitute an attribute value of the media attribute are substituted for an attribute value of “500000” of the bandwidth attribute and a numerical value of “0” corresponding to the present time, respectively. Thereby, the video acquirer 110B creates a URL including a file name of “500000/0.mp4v” of media segments from the MPD data 4B, and transmits an HTTP GET request including this URL to the DASH server 200B.

When receiving the HTTP GET request via the communication interface 220, the video supplier 210B of the DASH server 200B codes the captured video supplied from the video receiver 240 to create media segments corresponding to the HTTP GET request. Then, the created media segments are transmitted to the DASH client 100B. In the aforementioned example, media segments having the bit rate of 500 kbps are supplied to the DASH client 100B.

After that, when the user performs operation for causing the pan-tilt-zoom mechanism of the PTZ camera 300 to operate, the video acquirer 110B creates a Request-URI for operating the pan-tilt-zoom mechanism based on an id attribute and the range attribute of the Representation element and the device attribute of the SegmentTemplate element in the MPD data. Then, as shown in FIG. 9, the video acquirer 110B transmits an HTTP GET request including this Request-URI to the DASH server 200B.

Description will be given for this operation with reference to the example in FIG. 11. When the user performs operation of setting the pan angle as 40° within a range indicated by the range attribute, the video acquirer 110B substitutes the substitution variables of $RepresentationID$ and $Number$ constituting an attribute value of the device attribute for “pan” which is an attribute value of the id attribute and “40°” which is a value of the pan angle, respectively. Thereby, the video acquirer 110B creates a Request-URI ending with “pan-40” from the MPD data 4B to transmit an HTTP GET request including this Request-URI to the DASH server 200B.

When receiving the HTTP GET request via the communication interface 220, the video supplier 210B of the DASH server 200B transmits an HTTP response which shows success of the request to the DASH client 100B. Moreover, the video supplier 210B refers to the Request-URI of the received HTTP GET request to thereby identify a classification of control and the control parameter value designated by the user and notifies the camera controller 230 of the classification of the control and the control parameter value which are identified. In the aforementioned example, the video supplier 210B notifies the camera controller 230 of an effect that pan control has been designated by the user and “40°” which is the value of the pan angle.

The camera controller 230 controls the PTZ camera 300 via the communication interface 250 based on the classification of the control and the control parameter value which are notified. In the aforementioned example, the camera controller 230 controls the PTZ camera 300 so as to have the pan angle of 40°.

The video acquirer 110B of the DASH client 100B which has received the HTTP response transmits an HTTP GET request for requesting media segments having the same file name to the DASH server 200B. When receiving the HTTP GET request via the communication interface 220, the video supplier 210B creates media segments corresponding to the HTTP GET request, and transmits the created media segments to the DASH client 100B.

Note that, after this, the DASH client 100B requests transmission of subsequent media segments having the same bit rate to the DASH server 200B sequentially, and the DASH server 200B transmits the requested media segments to the DASH client 100B sequentially.

### (Additional Matter of Embodiment 3)

The DASH client 100B may be configured so that the user is able to receive designation of the pan angle of the PTZ camera 300, and may be configured so as to simply receive instruction which has an effect that the PTZ camera 300 is to be subjected to pan control without receiving the designation of the pan angle.

In this case, by substituting only $RepresentationID$ among two substitution variables constituting the attribute value of the device attribute for the attribute value of “pan” of the id attribute, the video acquirer 110B is to create a Request-URI ending with “pan-$number$” and to transmit an HTTP GET request including this Request-URI to the DASH server 200B.

The DASH server 200B which has received such an HTTP GET request is to control the PTZ camera 300 so as to increase the current pan angle by only an angle equal to an increment value. For example, in a case where the MPD data transmitted to the DASH client 100B by the DASH server 200B is the MPD data 4B of FIG. 11 and the current pan angle of the PTZ camera 300 is 40°, the PTZ camera 300 is controlled so as to have the pan angle of 50°.

Alternatively, the DASH server 200B which has received the HTTP GET request as above may control the PTZ camera 300 so that the pan angle becomes a predetermined default value (for example, 0°).

### (Overview of Embodiment 3)

As above, the present invention is able to be realized as each following configuration.

### (Configuration 1)

A mechanism for supporting new media representation which is not supported by MPEG-DASH currently, in which use of MPEG-DASH is enabled in an IP camera which generates media contents and a content processing device such as a video encoder.

### (Configuration 2)

The mechanism according to the configuration 1, in which definition of an MPD of the MPEG-DASH is extended as follows so as to support new media representation.

1. A new value of “application/device” is added to a mime-type attribute of a Representation element in the MPD. This shows that there are an additional device and special media representation in a DASH server which is able to be accessed from a DASH client.
2. A range attribute which is new is added to the Representation element in the MPD. With this attribute, a minimum value, a maximum value and an increment value of device specific media representation which is supported by the DASH server are able to be designated.
3. A Device attribute which is new is added to a SegmentTemplate element of an adaptation set to designate a template for forming a URL to access device specific media representation. Only substitution parameters of “$RepresentationID$” and “$Number$” are able to be used for this attribute.

### (Configuration 3)

The mechanism according to the configuration 1, in which, in the case of receiving the MPD of the configuration 2, the DASH client performs either identification of various device specific representation for acquiring user preference or independently making determination based on logic incorporated for accessing the various media representation which is usable in the DASH server.

### (Configuration 4)

The mechanism according to the configuration 1, in which, in the case of desiring to access any of device specific representation when receiving the MPD of the configuration 2, the DASH client transmits an HTTP GET request that a request-uri thereof is constructed by using a “device” attribute of a Segment Template element in accordance with a rule designated with DASH to the DASH server.

### (Configuration 5)

In the configuration 1, when the DASH server receives an HTTP GET request showing an intention of accessing the device specific representation of the configuration 4, in order to generate a content with the selected representation, the DASH server sets up a device by using a value for this representation, which is designated by the user. Based on success/failure of a request, a result thereof is transmitted as an HTTP response including an appropriate result code. In the case of success of the response code, the server transmits new media representation for all subsequent media requests from this client. In the case of “failure” of the response code, the server transmits media representation which is currently active with respect to a media request after that.

### (Configuration 6)

In the configuration 1, when receiving a GET request showing an intention of accessing the device specific representation of the configuration 4 without designating an HTTP parameter, in order to generate a content with the selected representation, the DASH server sets up a device by using an increment value of default for this representation. Based on success/failure of a request, a result thereof is transmitted as an HTTP response including an appropriate result code. In the case of success of the response code, the server transmits new media representation for all subsequent media requests from this client. In the case of “failure” of the response code, the server transmits media representation of a media request after that, which is currently active.

### (Configuration 7)

The mechanism according to the configuration 1, in which, when receiving representation of the HTTP response of the configuration 4, the DASH client transmits a request of media segments designated with an MPD based on a “media” attribute of Segment Template.

### Embodiment 4

Description for a camera video reproduction system according to another one embodiment of the present invention with reference to drawings will be as follows. Note that, for convenience of the description, as to members which have the same functions as those of members described in the aforementioned embodiments, the same reference signs are assigned, and description thereof will be omitted.

The camera video reproduction system according to the present embodiment includes a DASH client 100 and an IP camera 300′. The IP camera 300′ is provided with a pan-tilt-zoom function.

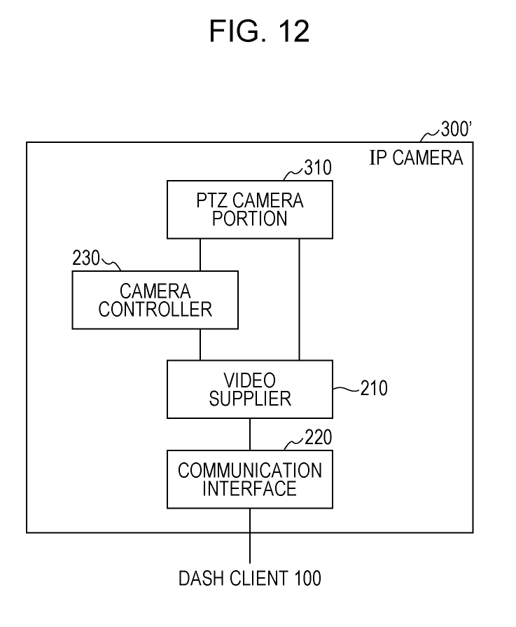

Description will hereinafter be given for a main configuration of the IP camera 300′ with reference to FIG. 12.

FIG. 12 is a block diagram showing the main configuration of the IP camera 300′.

As shown in FIG. 12, the IP camera 300′ is provided with the video supplier 210, the communication interface 220, the camera controller 230 and a PTZ camera portion 310.

The PTZ camera portion 310 corresponds to the PTZ camera 300 in the embodiments 1 to 3.

As this configuration shows, it can be also said that the IP camera 300′ is a camera that a function as the DASH server 200 is added to the PTZ camera 300.

Note that, a person skilled in the art who referred to the embodiment 1 will easily understand that the IP camera 300′ is able to efficiently inform the DASH client 100 of a range of a parameter value (for example, range of a pan angle) supported by itself.

### (Other Additional Matter)

Examples of the DASH servers of the embodiment 1 to the embodiment 3 include devices such as a server, a PC (personal computer) and a media processing system. Moreover, examples of the DASH clients of the embodiment 1 to the embodiment 4 include a digital television, a recorder, an STB (set-top box), a PC, a mobile phone, a smart phone, a tablet terminal, a game machine, a PDA (personal digital assistant).

The DASH server may distribute a real-time video to the DASH client or may distribute a video which has been stored on demand.

The camera video reproduction system may include one DASH server and two or more DASH clients.

### (Other Additional Matter 2)

The parameters such as the pan angle, the tilt angle and the zoom factor of the PTZ camera which are shown in the embodiment 1 to the embodiment 3 are control parameters when being taken from a direction in which a video is captured. On the other hand, it is also possible to substitute them for control parameters taken from a side of a video which has been captured. That is, when it is assumed that an entire video captured with one PTZ camera (full panoramic video, which is an entire video interpreted that what is actually output by a camera at a time is a video of a part of a region thereof) virtually exists, a pan angle is associated with position information in a lateral direction of a video of a partial region with respect to the entire video, a tilt angle is associated with position information in a longitudinal direction of a video of a partial region with respect to the entire video, and a zoom factor is associated with size information of a video of a partial region, which is to be segmented. Accordingly, even when the pan angle, the tilt angle and the zoom factor which are the control parameters that the PTZ camera supports are substituted for these of the position information in the lateral direction and the position information in the longitudinal direction of the video of the partial region and the size information of the video of the partial region, it goes without saying that the camera video reproduction systems shown in the embodiment 1 to the embodiment 3 are able to be carried out with the very same effect.

### [Implementation by Software]

Last, each block of the DASH client 100 (100A, 100B), the DASH server 200 (200A, 200B) and the IP camera 300′ (hereinafter, referred to as “each device”), particularly the video acquirer 110 (110A, 110B) and the video supplier 210 (210A, 210B), may be realized in a hardware manner by a logic circuit formed on an integrated circuit (IC chip), or may be realized in a software manner by using a CPU (Central Processing Unit).

In the case of the latter, each device is provided with a CPU which executes a command of a program for realizing each function, a ROM (Read Only Memory) which stores the above-described program therein, a RAM (Random Access Memory) which develops the above-described program, a storage device (recording medium) such as a memory which stores the above-described program and various data therein and the like. Then, an object of the present invention is able to be achieved also by supplying a recording medium in which a program code (execution type program, intermediate code program, or source program) of a control program of each device, which is software for realizing the above-described functions, is recorded so as to be readable by a computer to each device which is described above and by reading and executing the program code recorded in the recording medium with the computer (or the CPU or an MPU).

As the above-described recording medium, a non-transitory tangible medium, for example, a kind of tapes such as a magnetic tape and a cassette tape, a kind of disks including a magnetic disk such as a floppy (registered trademark) disk/hard disk and an optical disk such as a CD-ROM/MO/MD/DVD/CD-R, a kind of cards such as an IC card (including a memory card)/optical card, a kind of semiconductor memories such as a mask ROM/EPROM/EEPROM (registered trademark)/flash ROM, a kind of logic circuits such as a PLD (Programmable logic device) and an FPGA (Field Programmable Gate Array) or the like is able to be used.

Moreover, each device may be configured so as to be connectable to a communication network to supply the above-described program code via the communication network. This communication network needs only to allow transmission of the program code and is not limited particularly. For example, the Internet, an intranet, an extranet, a LAN, an ISDN, a VAN, a CATV communication network, a virtual private network, a telephone line network, a mobile communication network, a satellite communication network and the like are able to be utilized. In addition, a transmission medium constituting this communication network needs only to be a medium which allows transmission of the program code, and is not limited to one of a special configuration or type. For example, wired one such as an IEEE 1394, a USB, a power-line carrier, a cable television line, a telephone line, or an ADSL (Asymmetric Digital Subscriber Line) line and radio one such as infrared rays like an IrDA or a remote control, Bluetooth (registered trademark), an IEEE 802.11 radio, an HDR (High Data Rate), NFC (Near Field Communication), DLNA (Digital Living Network Alliance), a mobile phone network, a satellite channel, a ground wave digital network, are able to be utilized. Note that, the present invention is able to be realized in a form of a computer data signal embedded in a carrier wave, in which the above-described program code is embodied with electronic transmission.

The present invention is not limited to each of the above-described embodiments, various modifications are allowed within a scope shown in the Claims, and an embodiment which is able to be obtained by appropriately combining technical means respectively disclosed in different embodiments is also included in a technical scope of the present invention. Furthermore, by combining technical means respectively disclosed in each of the embodiments, a new technical feature is able to be formed.

### [Overview]

As above, a video acquisition device according to a first aspect of the present invention (DASH client 100) is provided with a video acquirer (video acquirer 110) which acquires, from a video supply device, a video (captured video) for which the video supply device (IP camera 300′) or an external device (PTZ camera 300) connected to the video supply device (DASH server 200) serves as a supply source and a metadata acquirer (video acquirer 110) which acquires, from the video supply device, metadata (MPD data) to be referred to for acquiring the video from the video supply device, and is characterized in that the device serving as the supply source of the video is provided with a function of supplying a video according to a parameter value received by the video supply device, the metadata includes a value (attribute value) which explicitly or non-explicitly indicates a range of the parameter value supported by the device serving as the supply source of the video, and the video acquirer acquires the video according to the parameter value within the range by referring to the value.

With the above-described configuration, the video acquisition device acquires the metadata including the value which indicates the range of the parameter value supported by the device serving as the supply source of the video from the video supply device, and refers to the value indicated in the metadata to acquire the video according to the parameter value within the range.

Accordingly, an effect is exerted that the video acquisition device is able to acquire, from the video supply device, the video according to a parameter value designated based on information informed from the video supply device.

It is desirable that, in the first aspect, a video acquisition device according to a second aspect of the present invention is further provided with a generator (video acquirer 110) which generates a URL to be transmitted to the video supply device for acquiring the video, the metadata indicates a character string to be referred to for generating the URL, and the character string includes a substitution variable to be substituted for the parameter value within the range by the generator in a case of generating the URL.

With the above-mentioned configuration, by transmitting the URL including the parameter value, the video acquisition device is to acquire the video according to this parameter value, which is supplied by the device serving as the supply source of the video, from the video supply device.

Accordingly, a further effect is exerted that, with only a single transmission of the URL, the video acquisition device is able to perform control of the device serving as the supply source of the video and acquisition of the video sequentially.

It is desirable that, in the second aspect, a video acquisition device according to a third aspect of the present invention is further provided with a notifier (video acquirer 110) which notifies the video supply device of the parameter value within the range before a time of transmitting the URL.

It is desirable that, as to a video acquisition device according to a fourth aspect of the present invention, in the second aspect or the third aspect, the video supply device is configured so as to transmit the video to the video acquisition device by time-dividing the video into a plurality of media segments, the generator is configured so as to generate, for each of the plurality of media segments, a URL to be transmitted to the video supply device for acquiring a media segment, and the metadata indicates a common character string that, for each of the plurality of media segments, the generator is to refer to for generating the URL for acquiring the media segment.

It is desirable that, in the first aspect, a video acquisition device according to a fifth aspect of the present invention is further provided with a notifier which notifies the video supply device of the parameter value within the range as a header value of a custom header of an HTTP request.

With the above-described configuration, the video acquisition device does not need to notify the video supply device of the parameter value within the range through a URL, so that an effect is exerted that the parameter value within the range is able to be notified to the video supply device without performing processing of generating the URL.

It is desirable that, as to a video acquisition device according to a sixth aspect of the present invention, in any aspect of the first aspect to the fifth aspect, the range of the parameter supported by the device serving as the supply source is indicated by a maximum value, a minimum value and an increment value of the parameter value supported by the device in the metadata.

It is desirable that, as to a video acquisition device according to a seventh aspect of the present invention, in any aspect of the first aspect to the sixth aspect, the metadata is MPD data specified with MPEG-DASH, and the MPD data includes an attribute value of a Representation element which indicates the range of the parameter value.

Moreover, a video supply device according to an eighth aspect of the present invention (DASH server 200, IP camera 300′) is provided with a video supplier (video supplier 210) which supplies, to a video acquisition device (DASH client 100), a video (captured video) for which an own device (IP camera 300′) or an external device (PTZ camera 300) connected to the own device (DASH server 200) serves as a supply source and a metadata supplier (video supplier 210) which supplies, to the video acquisition device, metadata which the video acquisition device refers to for acquiring the video from the own device, and is characterized in that the device serving as the supply source of the video is provided with a function of supplying a video according to a parameter value received by the own device, and the metadata includes a value which explicitly or non-explicitly indicates a range of the parameter value supported by the device serving as the supply source of the video.

With the above-described configuration, an effect is exerted that the video supply device is able to efficiently inform the video acquisition device of the range of the parameter value supported by itself or external equipment connected to itself through the metadata.

It is desirable that, as to a video supply device according to a ninth aspect of the present invention, in the eighth aspect, the metadata indicates a character string to be referred to by the video acquisition device for generating a URL for acquiring the video, and the character string includes a substitution variable to be substituted for the parameter value when the video acquisition device generates the URL.

With the above-mentioned configuration a further effect is exerted that, by receiving the URL including the parameter value, the video supply device is able to perform control of the device serving as the supply source of the video and supply of the video to the video acquisition device sequentially.

It is desirable that, as to a video supply device according to a tenth aspect of the present invention, in the eighth aspect or the ninth aspect, the range supported by the device serving as the supply source is indicated by a maximum value, a minimum value and an increment value of the parameter value supported by the device in the metadata.

It is desirable that, as to a video supply device according to an eleventh aspect of the present invention, in any aspect of the eighth aspect to the tenth aspect, the metadata is MPD data specified with MPEG-DASH, and the MPD data includes an attribute value of a Representation element which indicates the range of the parameter value.

A video acquisition method according to a twelfth aspect of the present invention includes a video acquisition step of acquiring, from a video supply device, a video for which the video supply device or an external device connected to the video supply device serves as a supply source, and a metadata acquisition step of acquiring, from the video supply device, metadata referred to for acquiring the video from the video supply device in the video acquisition step, and is characterized in that the device serving as the supply source of the video is provided with a function of supplying a video according to a parameter value received by the video supply device, the metadata includes a value which explicitly or non-explicitly indicates a range of the parameter value supported by the device serving as the supply source of the video, and, in the video acquisition step, the video according to the parameter value within the range is acquired by referring to the value.

With the above-described configuration, the video acquisition method exerts a working effect same as that of the video acquisition device according to the first aspect of the present invention.

A video supply method of a video supply device according to a thirteenth aspect of the present invention includes a video supply step of supplying, to a video acquisition device, a video for which an own device or an external device connected to the own device serves as a supply source and a metadata supply step of supplying, to the video acquisition device, metadata which the video acquisition device refers to for acquiring the video from the own device, and is characterized in that the device serving as the supply source of the video is provided with a function of supplying a video according to a parameter value received by the own device, and the metadata explicitly or non-explicitly indicates a range of the parameter value supported by the device serving as the supply source of the video.

With the above-described configuration, the video supply method exerts a working effect same as that of the video supply device according to the eighth aspect of the present invention.

Note that, the above-described video acquisition devices (each video acquisition device of the first aspect to the seventh aspect) may be realized by a computer, and, in this case, a program for realizing the above-described video acquisition device with the computer by operating the computer as each element of the above-described information acquisition devices and a computer readable recording medium recording it therein are also included in the scope of the present invention. The same also applies to the above-described video supply devices (each video supply device of the eighth aspect to the eleventh aspect).

### INDUSTRIAL APPLICABILITY

The present invention is preferably applicable to a camera video distribution system.

### REFERENCE SIGNS LIST

100, 100A, 100B DASH client
110, 110A, 110B video acquirer
120 communication interface
130 reproducer
200, 200A, 200B DASH server
210, 210A, 210B video supplier
220 communication interface
230 camera controller
240 video receiver
250 communication interface
300 PTZ camera
300′ IP camera
310 PTZ camera portion

1-5. (canceled)

6. A video acquisition device, comprising:
a video acquirer configured to acquire, from a video supply device, a video; and
a metadata acquirer configured to acquire, from the video supply device, metadata; wherein
the video acquirer is configured to supply an URL to the video supply device and acquire a video in accordance with the URL from the video supply device, wherein the URL includes a parameter value into a query, and
the metadata includes information regarding the parameter value supported by the video supply device.

7. A video supply device, comprising:
a video supplier configured to supply, to a video acquisition device, a video; and
a metadata supplier configured to supply, to the video acquisition device, metadata; wherein
the video supplier is configured to receive an URL from the video acquisition device and supply a video in accordance with the URL to the video acquisition device, wherein the URL includes a parameter value into a query, and
the metadata includes information regarding the parameter value supported by the video supplier.

8. A non-transitory computer-readable medium including a program for causing a computer to operate as the video acquisition device according to claim 6, the program causing the computer to function as each of the above elements.

9. A non-transitory computer-readable medium including a program for causing a computer to operate as the video acquisition device according to claim 7, the program causing the computer to function as each of the above elements.
